(19) United States
(12) Patent Application Publication
(10) Pub. No.: US 2004/0190652 A1
(43) Pub. Date: Sep. 30, 2004

(54) Method and apparatus for mitigating the effects of non-ideal receiver processing

(75) Inventors: Kevin Jackson Gamble, Fort Lauderdale, FL (US); Stephen Carsello, Plantation, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/400,365

(22) Filed: Mar. 27, 2003

(51) Int. Cl. H04L 27/06

(52) U.S. Cl. 375/344; 375/319; 375/334

(57) ABSTRACT

A wireless receiver 200 and corresponding method 500 is arranged to mitigate the effects of non-ideal receiver processing and comprises: a signal source 202 for providing an injection signal that is controlled to have a unique frequency at each of a plurality of time periods; and a non-ideal receiver device 208 constructed to use the injection signal for down converting a received signal having a known frequency to collect a plurality of waveform samples, each having a desired characteristic that varies with the unique frequency and an undesired characteristic, wherein one of the plurality of waveform samples with the undesired characteristic removed will retain the desired characteristic of the received signal.

### FIELD OF THE INVENTION

This invention relates in general to communication systems, and more specifically to a method and apparatus for mitigating or reducing the effects or impact of non-ideal receiver processing when attempting to detect a transmission in the presence of a frequency mismatch between a transmitter and a receiver.

### BACKGROUND OF THE INVENTION

In radio communication systems it is often necessary that a transmitter and a receiver be at the same frequency or at a known frequency mismatch in order to establish an effective communication link. It can be difficult to achieve the desired level of frequency match between the transmitter and the receiver in a short time period since the first step is to determine whether an attempt to communicate is occurring and this often happens when the frequency mismatch is largest, e.g. before any correction for mismatch can occur. Furthermore receivers are not ideal and typically exhibit one or more undesired outputs, such as a DC offset that may be confused with characteristics of a desired signal that are required to facilitate communications by, for example, determining the frequency mismatch or whether an attempt to communicate has occurred. Clearly a method and apparatus is needed for mitigating or reducing the effects or impact of non-ideal receiver processing, for example, when attempting to detect a transmission in the presence of a frequency mismatch between a transmitter and a receiver.

### BRIEF DESCRIPTION OF THE DRAWINGS

The accompanying figures, where like referece numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative view, the system elements of a wireless communications environment;

FIG. 2 depicts, in an exemplary form, a block diagram of a wireless receiver;

FIG. 3 depicts a representative waveform of an exemplary received signal;

FIG. 4 depicts a time domain representation of a waveform sample comprising a multiplicity of samples with an undesired characteristic and the removal thereof;

FIG. 5 depicts a frequency domain representation of a waveform resulting from a nominal plurality of waveform samples with an undesired characteristic;

FIG. 6 depicts a frequency domain representation of waveforms resulting from a nominal and a received plurality of waveform samples;

FIG. 7 and FIG. 8 depict a frequency domain representation of waveforms resulting from a nominal and a received plurality of waveform samples showing a first and second frequency offset; and

FIG. 9 depicts the internal process flow for the FIG. 2 wireless receiver to detect a desired characteristic of a received signal and adjust a signal source frequency to match the received signal.

### DETAILED DESCRIPTION OF PREFERRED EMBODIMENT

In overview, the present disclosure concerns wireless communications devices that support two way communication. More particularly various inventive concepts and principles embodied in methods and apparatus for the mitigation and reduction of undesired effects of non-ideal receivers or processing thereby in the detection of a transmission given a frequency mismatch between a receiver and a transmitter are discussed. The wireless communications devices of particular interest are those using frequency shift keying although the inventive principles and concepts apply to various devices using various forms of modulation.

As further discussed below various inventive principles and combinations thereof are advantageously employed to use existing facilities within the wireless communication device in the receive mode to extend its functionality for the purpose of detecting a transmission and adjusting the communications device frequency to match the transmitter of such transmission.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued. It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

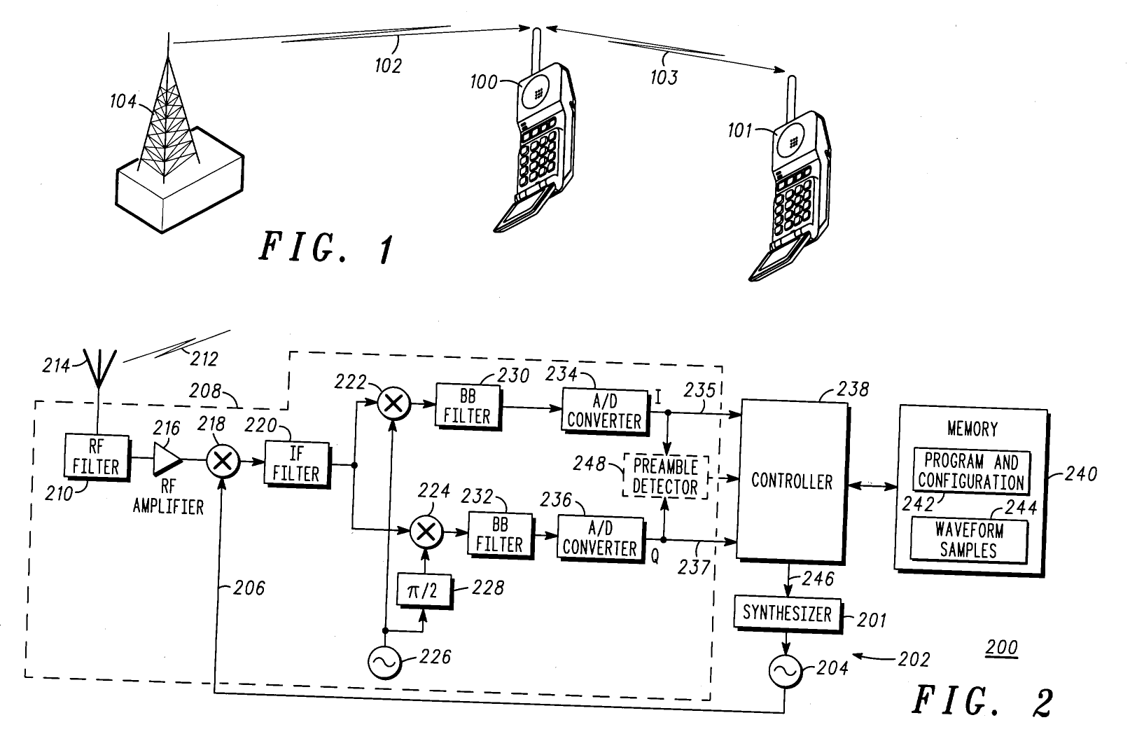

Referring to FIG. 1, a simplified and representative view of the system elements of a wireless communications environment will be discussed and described. A wireless communication device 100 receives a signal 102, 103 from a transmitter 104, 101. The frequency of the received signal 102, 103 is directly related to or determined by the frequency of a signal provided by a signal source in the transmitters 104, 101. This frequency will likely be different from the frequency of a corresponding signal source in the receiver of the wireless communication device 100. The difference between these frequencies translated to the nominal channel frequency or the frequency that the signal on the channel is supposed to be at is called the frequency mismatch between the transmitter and receiver. This frequency mismatch in part or in combination with other non-ideal characteristics in the wireless communication device can result in missed communications attempts. For example, this frequency mismatch for carriers in the 900 MHz range can be as much as 9 KHz if both signal sources have a 5 part per million tolerance and this is typical for the wireless communications devices 100, 101. This large frequency offset particularly arises when the wireless communications devices 100, 101 are engaged in talk around or direct communications as suggested by the signal 103. The large frequency offset in talk around is further exacerbated since the talk around communications is entirely asynchronous, indicating that the receiver has no indication when the transmitter will attempt a communications. Battery life concerns together with the infrequent nature of talk around dictate the asynchronous mode of operation for wireless handsets equipped to engage in talk around communications.

These effects are mitigated when the wireless communication device and its component wireless receiver are arranged to operate as described below. The wireless communication device 100 can be a typical cellular telephone or handset such as those available from manufacturers, such as Motorola. One such handset, commonly referred to as the i95, can advantageously utilize the principles and concepts when enhanced as described in the following disclosure. The transmitter is common to communications infrastructure systems similar to Integrated Digital Enhanced Network equipment available from Motorola and utilized in networks operated by service providers, such as Nextel Communications. Alternatively, the transmitter is included in a second portable wireless handset, wherein both handsets are configured to communicate directly with one another or in a direct mode as discussed above.

Referring to FIG. 2, a block diagram of an exemplary wireless receiver 200 and controller in relevant part will be discussed and described. The wireless receiver 200 is a component of the wireless communication device 100 and is comprised of one or more components or elements that in practice can exhibit non-ideal characteristics such as frequency instability, DC offsets and spurious signals. These non-ideal characteristics arise from the statistical nature and variation of the components used in the construction of the wireless receiver, environmental factors such as battery voltage level and temperature, and other unplanned interactions among elements of a real receiver.

Other components both passive, such as capacitors, and active, such as transistors, operational amplifiers, and digital-to-analog converters exhibit variability from part-to-part, over temperature and with age. Another factor making such equipment non-ideal can be physical layout contributing to signal coupling, ground current and impedance mismatches. It is therefore not economically feasible to manufacture an electronic product such as a wireless communication device and the wireless receiver therein with no variability, especially for the commercial marketplace. There are several impacts of variability on the wireless receiver. Among them may be direct current (DC) offsets, spurious signals, and frequency variation. A DC offset, as from ground current paths, may result in a received signal being shifted up or down by the amount of the DC offset. A spurious signal, sometimes the result of undesired interaction or coupling between components, can result in extra data being added to a received signal. Frequency variation is often the result of the inherent variations of the components comprising and surrounding a signal source and other factors such as temperature and component changes with age. Frequency variation can cause the received signal to be shifted above or below its intended frequency. It is then necessary to mitigate the effects of the non-ideal receiver when processing a received signal.

The wireless receiver 200 is arranged to mitigate the effects of non-ideal receiver processing and comprises a signal source 202, such as a synthesizer 201 controlling the frequency of a voltage controlled oscillator 204 to provide an injection signal 206 to a non-ideal receiver device 208. The synthesizer 201 is referenced to an oscillator (not shown) that is typically specified to be stable within 5 ppm (parts per million). The non-ideal receiver device 208 is comprised of a radio frequency filter 210 that operates to limit the energy of a received signal 212 from an external antenna 214 to a desired frequency range, an amplifier 216, a mixer 218 and an intermediate frequency (IF) filter 220 all inter coupled as depicted and operating as generally known to provide a signal down converted to the intermediate frequency at the output of the IF filter 220. In an exemplary digital receiver, the signal is split, and mixed to two base band signals by mixing with a first IF mixer 222 and a second IF mixer 224 where the IF local oscillator 226 is shifted 90 degrees by a phase shifter 228. The resulting base band signals are filtered by filters 230 and 232 and converted by analog-to-digital converters 234 and 236 to give a resultant I and Q digital outputs 235, 237.

The frequency of the injection signal 206 may match or nearly match the received signal in the case of a zero intermediate frequency receiver or be deliberately offset an amount equal to an intermediate frequency, such as 13.7 megahertz. It is understood in the discussions below where the signal source is adjusted to allow the injection frequency to correct for a frequency mismatch with the received signal that it is in this context.

The I and Q outputs 235, 237 of the non-ideal receiver device 208 or signals thereon are sent or coupled to a preamble detector 248 and a controller 238, normally including a digital signal processor (DSP). The controller is further coupled to a memory 240 comprising storage for both general use, including program instructions and configuration data 242 for the controller, as well as waveform samples 244 or information corresponding thereto used in the further processing of the received signal. The controller 238 is coupled to the signal source 202 and is operable to adjust the frequency of the signal source by a control signal 246. The preamble detector 248 operates as described below and may be either included as a function of the controller (DSP) or may be an additional hardware element, such as an integrated circuit constructed or programmed to perform a more or less dedicated function.

The elements of the wireless receiver are generally known and available. The signal source 202 may be, for example, a fractional-N synthesizer. The mixers, filters, oscillators, phase shifter, and analog-to-digital converters are all commercially available and known in the art. In the exemplary case where the controller is or includes a DSP, various device are known and available from manufacturers, such as Motorola, Inc. or Texas Instruments. The memory, comprising volatile and non-volatile memory is also commercially available and known. The preamble detector, if implemented in software, will be implemented, typically in the DSP. When the preamble detector is implemented in hardware a number of commercially available field programmable gate arrays or the like are suitable for performing the tasks, given the principles and concepts disclosed herein. Implementing a DSP task in logic hardware is known in the art and can be accomplished by one of ordinary skill in the art without undue experimentation given the discussion and explanations herein.

In operation, the signal source 202 is used for providing an injection signal 206 that is controlled to have a unique frequency at each of a plurality of time periods. For example, in one embodiment adapted for detecting a 270 millisecond (ms) preamble, 3 time periods, each 2.5 milliseconds (ms) long and spaced each from the other by 87.5 ms are utilized. The non-ideal receiver device 208 is constructed to use the injection signal for down converting a received signal having a known or nominal frequency. The down conversion is repeated to collect a plurality of waveform samples, one corresponding to each of the time periods, with each having a desired characteristic that varies with the unique frequency and an undesired characteristic where the undesired characteristic results from the non ideal receiver device. Note that the waveform sample in the digital receiver embodiment is comprised of a sequence of samples, specifically I/Q sample pairs taken over the 2.5 ms window at a sampling rate of, preferably, 51,200 samples per second or 1281I/Q sample pairs in each 2.5 ms time period. Thus each waveform sample is comprised of a multiplicity of samples of a received waveform or a received sample sequence that is collected over one of the 2.5 ms time periods

The received signal, preferably, comprises a preamble and typically that is followed by a message or payload. The desired characteristic can correspond to a frequency shift keyed (FSK) signal that toggles between two carrier frequencies, such as+/−6400 Hz from the nominal carrier or receive signal or channel frequency with the FSK signal representing the preamble signal. The FSK signal or preamble signal is preferably a periodic signal and the observation time or sampling time, in this case 2.5 ms, is chosen to ensure that at least one full cycle of the periodic preamble signal is observed or sampled for later use in a mathematical correlation process with an expected waveform sample or waveform that one would expect to observe during the sampling time period. The preamble has two purposes. First, the wireless communication device may be placed in a power saving mode with only the preamble detector operable to scan for the preamble, specifically the desired characteristic, indicating that the preamble signal is present and thus may be intended for the wireless communication device 100. Only when the desired characteristic is determined to be present does the rest of the wireless communication device have to power up to further decode and possibly receive the message, thereby conserving battery power. Second, the known or predetermined desired characteristic of the preamble signal can be used in calculations to determine any frequency offset or mismatch between the signal source 202 and that of the received signal 212, generally referred to as frequency mismatch between the receiver and the transmitter

The undesired or undesirable characteristic is any output or artifact or parasitic result of the receiver that is known to occur and that alters the plurality of waveform samples or corresponding received sample sequences and subsequent received waveform from their ideal form. For example, circuit parasitic and component variations in the wireless receiver 200 may result in a DC offset at the outputs of the non ideal receiver device and this DC offset will effect or alter the plurality of waveform samples.

At each of the plurality of time periods the injection frequency is set to a new or unique frequency that is predetermined as either an absolute frequency or in actuality an offset from the previous frequency. For example, the first frequency may be a nominal frequency of the signal source (typically the nominal carrier or received signal frequency minus the IF frequency) and subsequent unique frequencies can be shifted+/−500 Hz from the previous unique frequency. Each time the injection frequency is shifted the resulting waveform sample, comprised of a multiplicity of samples or received sample sequence, will be shifted in frequency a corresponding and predetermined amount. In the case where the undesired characteristic is a DC offset, the undesired characteristic may be removed by subtracting an average value of the multiplicity of samples from each of the samples. This is equivalent to subtracting the average value of each of the plurality of waveform samples from the respective waveform sample. Thus, by finding the average value of all the samples at a given time period and subtracting the average from each of the multiplicity of samples, the average value for the corresponding waveform sample is removed, as further discussed below with reference to FIG. 4.

It is likely that a frequency offset will exist between the frequency of the received signal 212, more specifically, a transmitter of the received signal, and the signal source 202 of the wireless receiver. This offset may result in the desired characteristic, for example, a tone or tone sideband of the preamble signal, being shifted in such a manner as to fall on top of the undesired characteristic, such as the DC offset resulting from the non ideal receiver processing and thus to be removed in the process of removing the undesired characteristic, such as this DC offset or another undesired characteristic. By taking and analyzing a plurality of waveform samples using a different injection signal frequency for each during each of the corresponding plurality of time periods the desired characteristic will be shifted in such a manner that at least one of the plurality of waveform samples, after the undesired characteristic is removed, will retain the desired characteristic of the received signal. In fact normally at most one of the plurality of waveform samples, after the undesired characteristic has been removed, will lose the desired characteristic of the preamble signal. This can be important when the waveform samples are used to provide diversity gain, such as when the nominal received frequency is changing with each waveform sample as is explained further below.

When the preamble detector 248 determines that one of the plurality of waveform samples with the undesired characteristic removed does in fact retain the desired characteristic, as by a frequency domain and time domain correlation function or operation, this waveform sample or corresponding received sample sequence can be used by the controller 238 to find or determine and then or thus correct a frequency offset with the received signal. The plurality of waveform samples can be adjusted to remove any effect introduced by the unique frequency of the injection signal or alternatively the controller can use the waveform sample as is to determine a frequency offset or mismatch. The controller compares the adjusted or non adjusted plurality of waveform samples, or a desired characteristic thereof, for example, a power or energy distribution versus frequency of the waveform sample as received, to an expected waveform sample or corresponding power or energy distribution in memory at waveform samples table 244 to calculate a frequency offset between received signal 212 and a nominal frequency of the signal source 202.

This can be done in a variety of ways depending on the exact nature of the desired characteristic and any particular preamble signal type. For example, a discrete Fourier transform (DFT) can be performed and then the magnitude of respective components of the DFT can be squared to provide a pattern for each of the plurality of waveform samples and this can be compared to equivalent properties for the expected waveform samples. The shift, readily determined with known correlation techniques between the actual and expected pattern will be a good estimate for the frequency offset. Once the frequency offset has been determined, the controller 238 may apply a control signal 246 (in practice a divide ratio for a programmable divider in a synthesizer is loaded) to adjust the signal source according to the frequency offset thereby controlling the injection signal to compensate for a frequency mismatch with the received signal and a transmitter thereof. Note that if the frequency offset is calculated using a waveform sample that has not been corrected for the unique injection frequency the control signal 246 applied will need to compensate for this effect whereas if the effect has been removed first the applied control signal will not need to account for the purposeful adjustment to the injection signal.

An alternate mode will now be discussed with reference to FIG. 2. A wireless receiver 200 is arranged to determine the existence of or detect a message identifier in a received signal 212. The wireless receiver 200 comprises the signal source 202 for providing an injection signal 206 that is controlled to have a first frequency during a first time period and a second frequency during a second time period, the second frequency differing from the first frequency. A non-ideal receiver device 208 is arranged to use the injection signal 206 for down converting the received signal having a known or nominal frequency to recover a waveform, where low frequency components, for example, a DC offset, have been removed from the waveform. Further included is a controller 238 that is operable to compare components of the waveform recovered during the first time period and during the second time period to expected components of the message identifier to determine if the message identifier is present. The message identifier may be a tone or, preferably, a periodic signal represented by a pattern of tonal components at predetermined frequencies that were used to modulate the received signal to form a preamble to a message. The first injection signal frequency can be a nominal frequency of the signal source 202 and the second injection signal frequency would then be offset from the first frequency a known amount, such as the 500 Hz noted above. The controller 238 is further operable to a use the message identifier and an expected waveform sample table 244 to calculate a frequency offset between the signal source 202 and the received signal 212. When the message identifier is determined to be present, controller 238 is coupled to the signal source 202 and operable to adjust the frequency of the injection signal 206 according to the frequency offset thereby controlling the signal source 202 to compensate for a frequency mismatch with the received signal.

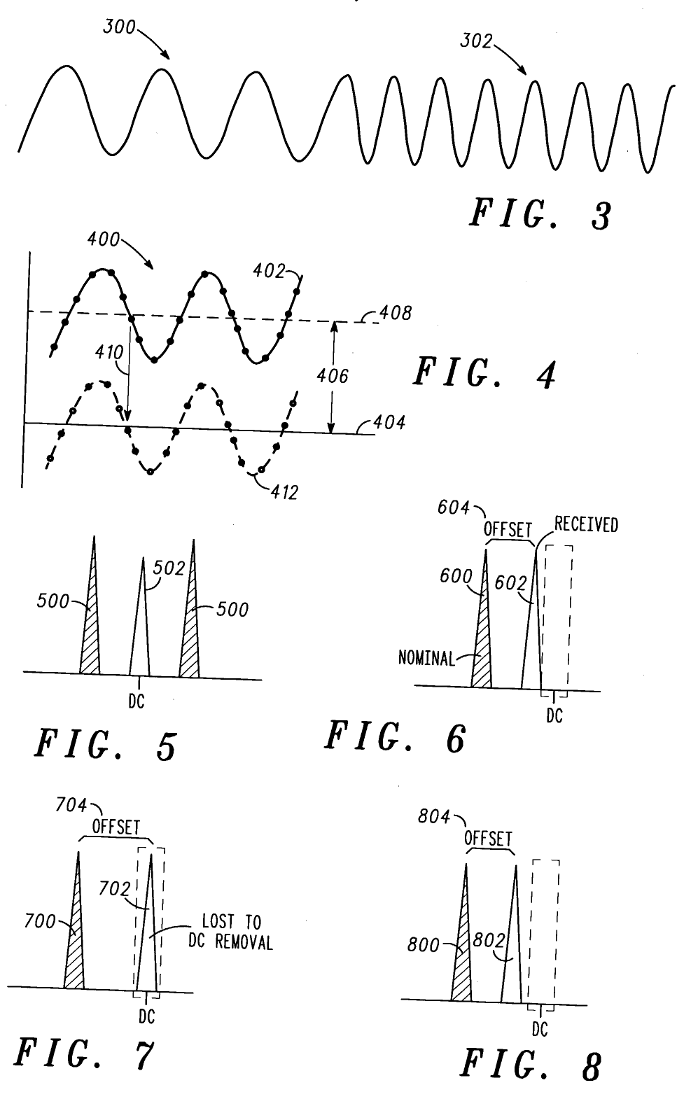

Referring to FIG. 3, a waveform of an exemplary transmission is discussed and described. The waveform comprises a FSK signal that toggles between two frequencies 300, 302, such as+/−6400 Hz of the carrier frequency. The waveform is a continuous signal and repeats in a periodic manner. This waveform is indicative of a preamble and will ordinarily be followed by a waveform representing a message or payload. Note that the preamble signal may be transmitted multiple times and some of these transmissions may be on different carrier frequencies, such as could be experienced with a preamble signal for a frequency hopped system.

Referring to FIG. 4, a time domain representation of a multiplicity of samples corresponding to one exemplary waveform sample of the plurality of waveform samples with an undesired characteristic and the removalthereof is discussed and described. Note that this exemplary waveform is a simple example comprising a portion of a tone and that an actual preamble waveform will be more complex however the following discussion will apply equally to an actual waveform. The wireless receiver 200 captures a multiplicity of samples over a sampling window, such as 2.5 ms, where a single sample is represented by a dot, such as the dot 400. The multiplicity of samples forms a waveform sample 402 that due to the effects of a non-ideal receiver device is shifted above a nominal value 404 by an amount 406. This represents a DC offset that can be an undesired characteristic resulting from the non ideal receiver. Taking an average of the multiplicity of samples results in a value 408. To eliminate this DC offset the average value 408 is subtracted from each of the multiplicity of samples as shown, for example, by 410 and a shifted or corrected waveform sample 412 results around the nominal DC value of zero 404 when the average value has been removed or subtracted from each of the multiplicity of samples. Any undesired characteristic imparted to the multiplicity of samples that is susceptible to a predetermined characterization or set of rules may be eliminated in a similar manner.

Referring to FIG. 5, a frequency domain representation of a waveform, such as the waveform sample 402, comprised of a multiplicity of samples with an undesirable characteristic is discussed and described. A Fourier or discrete Fourier transform of the waveform 402 will show a double lobe 500 for each tone frequency included in the waveform. An undesired characteristic, in this case a DC offset, appears as a spike 502. Using the technique described above related to FIG. 4, the spike 502 may be removed and will not then interfere in later calculations involving the waveform corresponding to the lobes 500. The preamble detector 248 is able to identify the desired tones, for example by a frequency domain correlation operation that amounts to comparing the location in frequency of energy that is detected to the location of such energy that was expected. Once identified, the preamble detector may alert the rest of the wireless receiver to begin further steps to recover the message 302.

Referring to FIG. 6, a frequency domain representation of expected and actual waveforms, using only one lobe for a tone to simplify the diagrams, that result from a nominal or expected Fourier transformation and a Fourier transform of received or actual multiplicity of samples is discussed and described. As shown above, a nominal waveform of a received signal 212 comprising a preamble tone with DC offset removed will appear in a frequency domain view as a lobe 600. In the case where the signal source and corresponding injection signal frequency is offset from the frequency of the received signal, and the transmitter thereof, the lobe is shifted in frequency an amount corresponding to the offset, as shown by lobe 602. The offset 604 is shown. The variation may stem from any or all of the above mentioned factors, such as temperature, age of the components, etc. Note that removal of DC or low frequency components will not remove the received signal energy or characteristic.

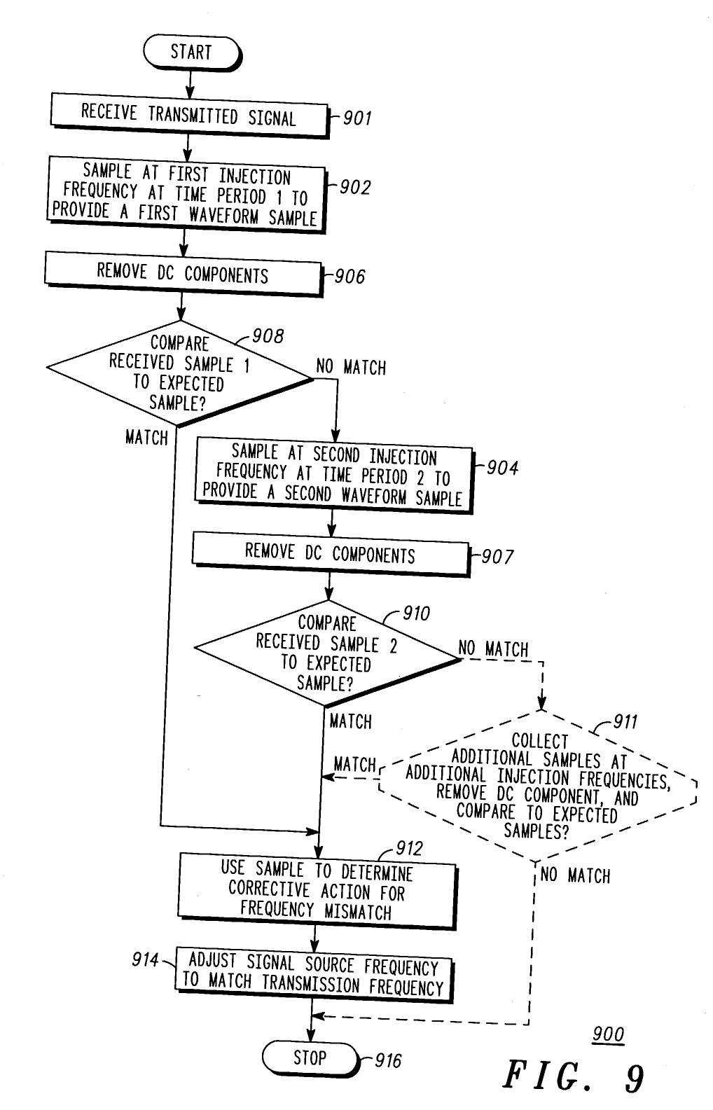

Referring to FIG. 7, a frequency domain representation of expected and actual waveforms, again using only one lobe for simplicity, that result from a nominal or expected Fourier transformation and a Fourier transform of received or actual multiplicity of samples including a first frequency offset is discussed and described. The frequency shift and resulting offset of FIG. 6 are not problems of themselves. Again a nominal waveform transform with lobe 700 is shown. A received waveform with a frequency shift due to frequency mismatch between the receiver or signal source 202 and transmitter is shown by lobe 702. Note, that lobe 702 is shifted by an offset 704 to a point in the frequency domain where its energy lies at the DC value. If the non ideal receiver device generates an undesirable characteristic that is a DC offset, applying the technique described for FIG. 4 to remove a DC value will result in lobe 704 being lost. In this case, the desired characteristic, for example, one lobe of a preamble tone is lost and the preamble may not be correctly identified or detected and if so, the wireless receiver will miss the intended message.

Referring to FIG. 8, a frequency domain representation of expected and actual waveforms, again using only one lobe for simplicity, that result from a nominal or expected Fourier transformation and a Fourier transform of received or actual multiplicity of samples including a second frequency offset is discussed and described. Again, the nominal waveform transformation lobe 800 is shown. As discussed in the description of FIG. 2, the received signal is sampled a multiplicity of times or observed over a multiplicity of intervals using a unique injection frequency at each of a plurality of times or observational intervals. The resulting lobe 802 showing an offset 804 is the result of the multiplicity of samples at one of the plurality of times or plurality of observation intervals with one of the unique injection frequencies and in this case fortuitously will not be affected by the removal of a DC value. The desired characteristic, namely the lobe and it twin lobe is likely to be correctly identified and the wireless receiver correctly alerted to an incoming message. The positive impact of sampling the received signal using a unique frequency for the injection signal at each of the plurality of times can be seen by a comparison of FIG. 7 and FIG. 8. The desired characteristic, in this case a tone of the preamble signal, is retained in at least one of the waveform samples after the undesired characteristic, in this case a DC offset, is removed. The unique frequency for each of the plurality of times is selected to increase the probability of retaining the desired characteristic in at least one of the plurality of waveform samples based on factors known about the wireless receiver, the received signal and the transmitter thereof and any prevailing environmental conditions. Note that if three observations are available, as in the preferred embodiment, no more than one of the received sample sequences will lose the desired characteristic due to the removal of the undesired characteristic.

Referring to FIG. 9, a flow chart of a method 900 of mitigating the effects of non-ideal circuitry in a received signal will be discussed and described. The wireless receiver of FIG. 2 may implement this method in order to detect a desired characteristic in one or more of a plurality of waveform samples and adjust a signal source frequency to match the received signal thereby eliminating a frequency mismatch between a transmitter and receiver. A received signal 212 with a known or nominal frequency and a desired characteristic is received 901 and down-converted with an injection signal 206 at a first unique frequency generated by the signal source 202 to collect a first waveform sample 902, preferably, comprising a multiplicity of samples during a first time period.

At 906 an operation is performed to remove an undesired characteristic from the first sample. For example, if the undesired characteristic is a DC offset, averaging the multiplicity of samples or the first waveform sample obtained during the first time period to calculate an average value and subtracting the average value from the corresponding waveform sample or each of the multiplicity of samples can be performed.

A comparison 908, for example a frequency domain and time domain correlation function, is performed to determine if the desired characteristic, corresponding to a preamble signal, is present in the first waveform sample. Note that the offset frequency used for the frequency domain correlation that maximizes this correlation will be the frequency mismatch between the received signal or first waveform sample and the nominal frequency of the receiver or signal source 202. Preferably, this frequency mismatch will be used to adjust the waveform sample or corresponding multiplicity of samples prior to the time domain correlation. If predetermined criteria are met, such as a correlation value satisfying a threshold that can be experimentally determined, the path designated match is followed to 912. If the predetermined criteria for a match are not met, the branch designated no match is followed and processing proceeds to 904. The received signal 212 is then down-converted at a second time period with the signal source 202 set to a second unique frequency to collect a second waveform sample 904 comprising a multiplicity of samples. The offset or difference between the first unique frequency and the second unique frequency is a predetermined amount, such as +/−500 Hz, that can be selected to reduce the chance that the desired information will be lost or removed in further processing to remove the undesired characteristic. Then 907 removes the undesired characteristic from the second sample as discussed above for the first sample at 906.

Next, a comparison 910 (similar to 908) is performed to determine if the desired characteristic corresponding to a preamble signal, is present in the second waveform sample. If the predetermined criteria are satisfied, the match branch is followed to 912. If the predetermined criteria are not met, the no match branch is followed to optional process 911 where additional samples at additional time periods using additional unique injection frequencies are obtained and compared to corresponding expected samples similar to 902, 906, 908 and 904, 907, 910 processes. If a match is found the method moves from 911 to 912. At some point, for example after 3 waveform samples have been obtained and no match found the method 900 stops. Note that at the first occurrence of a match indicating the preamble may be present or has been detected, collection of waveform samples is discontinued and the process moves to 912. This saves processing capacity, time, and battery life.

Following the determination that the desired characteristic of the received signal or the preamble is present at 908 or at 910 or at 911 if used, processing continues at 912 where the waveform sample used at 908, 910, 911 containing the desired characteristic is used for a set of further operations. Initially, any frequency offset due to the known unique injection frequency when collecting the corresponding waveform sample can optionally be removed to provide an adjusted waveform sample. Then a further determination as to proper corrective action is made using the frequency mismatch or offset, determined above at the corresponding process 908, 910, or 911, between the received signal 212 and a nominal frequency of the wireless receiver 200, that is, the signal source 202. The frequency offset or mismatch is used to determine how much to adjust the frequency synthesizer in order to eliminate the frequency mismatch. At 914 a control signal 246 is determined and applied to the frequency synthesizer to correct for the frequency mismatch, thereby adjusting the signal source 202 to match a nominal frequency of the wireless receiver to the received signal and the method then stops 916.

Of course after detecting the preamble and adjusting the wireless receiver to match the frequency of the received signal, any further processing to insure the received signal is addressed to the particular receiver can be undertaken and if so the message included with the received signal can be received. After receiving the message if one is forthcoming or determining that the message is not for the particular receiver, the wireless communication receiver will repeat the method beginning at 901.

The processes and apparatus discussed above, and the inventive principles thereof are intended to and will alleviate problems introduced by the inherent variation in signal source frequencies among wireless communication devices, given the artifacts of non ideal receiving devices. Using these principles of deliberately introducing offsets into the detection of a transmission will greatly simplify operation of such devices and does not add unnecessary overhead that other solutions can involve such as sending multiple waveforms as part of a preamble or sampling outside the bandwidth of the signal.

Various embodiments of methods and apparatus for determining frequency mismatches between transmitters and receivers in an efficient manner have been discussed and described. It is expected that these embodiments or others in accordance with the present invention will have application to many communication systems that have inherent mismatches due to real world considerations such as signal source instability and circuitry-induced offsets. The disclosure extends to the constituent elements or equipment comprising such devices and specifically the methods employed thereby and therein.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A wireless receiver arranged to mitigate the effects of non-ideal receiver processing comprising:
a signal source for providing an injection signal that is controlled to have a unique frequency at each of a plurality of time periods; and
a non-ideal receiver device constructed to use the injection signal for down converting a received signal having a known frequency to collect a plurality of waveform samples, each having a desired characteristic that varies with the unique frequency and an undesired characteristic at each of the plurality of time periods, wherein one of the plurality of waveform samples with the undesired characteristic removed will retain the desired characteristic of the received signal.

2. The wireless receiver of claim 1 wherein the unique frequency at each of the plurality of time periods is predetermined.

3. The wireless receiver of claim 1 wherein the undesired characteristic is a DC offset and the DC offset is removed by subtracting an average value of each of the plurality of waveform samples from said each of the plurality of waveform samples.

4. The wireless receiver of claim 1 wherein the received signal comprises a preamble signal, the preamble signal comprising the desired characteristic, the desired characteristic being a frequency shift keying signal that toggles between two predetermined frequencies and wherein the non-ideal receiver device further comprises a preamble detector operable to scan for the preamble.

5. The wireless receiver of claim 1 wherein:
the non-ideal receiver device collects the plurality of waveform samples, wherein at most one of the plurality of waveform samples with the undesired characteristic removed will not retain the desired characteristic of the received signal.

6. The wireless receiver of claim 1 further comprising:
a controller operable to compare the one of the plurality of waveform samples with the undesired characteristic removed with an expected waveform sample to calculate a frequency offset between the received signal and a nominal frequency of the signal source.

7. The wireless receiver of claim 6 wherein the controller is further coupled to the signal source and operable to adjust the signal source according to the frequency offset thereby controlling the injection signal to compensate for a frequency mismatch with the received signal.

8. A wireless receiver arranged to detect a message identifier in a received signal comprising:
a signal source for providing an injection signal that is controlled to have a first frequency during a first time period and a second frequency during a second time period, the second frequency differing from the first frequency;
a non-ideal receiver device arranged to use the injection signal for down converting a received signal having a known frequency to recover a waveform, where low frequency components have been removed from the waveform; and
a controller operable to compare components of the waveform recovered during the first time period and during the second time period to expected components of the message identifier to determine if said message identifier is present.

9. The wireless receiver of claim 8 wherein the first frequency is a nominal frequency of the signal source and the second frequency is offset from the first frequency a known amount.

10. The wireless receiver of claim 8 wherein the message identifier corresponds to a preamble to a message, the preamble comprising a frequency shift keying signal that toggles between two predetermined frequencies.

11. The wireless receiver of claim 10 wherein when the message identifier is present, the controller is further operable to determine a frequency offset between the received signal and the injection signal by comparing an information corresponding to an expected waveform to the waveform where low frequency components have been removed.

12. The wireless receiver of claim 11 wherein the controller is coupled to the signal source and operable to adjust the signal source according to the frequency offset thereby controlling the injection signal to compensate for a frequency mismatch with the received signal.

13. A method for a wireless receiver to mitigate the effects of non-ideal circuitry in a received signal comprising:
down-converting the received signal comprising a known frequency and a desired characteristic to collect a plurality of waveform samples, one waveform sample at each of a plurality of time periods, wherein a unique injection frequency is used for down-converting the received signal at each of the plurality of time periods; and
removing an undesired characteristic from each of the plurality of waveform samples wherein at least one of the plurality of waveform samples with the undesirable characteristic removed will retain the desired characteristic of the received signal.

14. The method of claim 13 wherein the desired characteristic of the received signal corresponds to a preamble of a message, the preamble further comprising a frequency shift keying signal that toggles between two known frequencies.

15. The method of claim 13 wherein the unique injection frequency at each of the plurality of time periods is predetermined.

16. The method of claim 15 wherein the unique injection frequency is one of a nominal frequency of a signal source, and a frequency with a known offset from the nominal frequency of the signal source.

17. The method of claim 13 wherein the undesired characteristic is a spurious signal resulting from the operation of the wireless receiver.

18. The method of claim 13 wherein the undesired characteristic is a DC offset.

19. The method of claim 18 wherein the removing step further comprises:
averaging each of the plurality of waveform samples to, respectively, calculate an average value; and
subtracting the average value from, respectively, the each of the plurality of waveform samples.

20. The method of claim 15 further comprising:
calculating a frequency offset between the received signal and a nominal injection frequency of the wireless receiver;
adjusting the frequency offset to remove an effect of the unique injection frequency; and
applying the frequency offset to compensate for a mismatch between the nominal injection frequency of the wireless receiver and the received signal.
